(19) United States
(12) Patent Application Publication
(10) Pub. No.: US 2014/0230905 A1
(43) Pub. Date: Aug. 21, 2014

(54) CONDENSATE DRAINAGE MEANS WITH FAULT MONITORING

(71) Applicants: Johannes Sinstedten, Korschenbroich (DE); Herbert Schlensker, Leverkusen (DE)

(72) Inventors: Johannes Sinstedten, Korschenbroich (DE); Herbert Schlensker, Leverkusen (DE)

(73) Assignee: BEKO Technologies GmbH, Neuss (DE)

(21) Appl. No.: 14/343,735

(22) PCT Filed: Sep. 7, 2012
(86) PCT No.: PCT/EP2012/067488

§ 371 Date: Mar. 7, 2014

(30) Foreign Application Priority Data
Sep. 8, 2011 (DE) 10 2011 053 411.3

(51) Int. Cl. F16K 37/00

(52) U.S. Cl. CPC F16K 37/0091
USPC 137/1; 137/551

(57) ABSTRACT

A method for fault monitoring of a discharge valve of a condensate drainage means of a pressurized gas system includes a closing step wherein the control circuit triggers a closing movement of the valve element in the direction of the closed position, and/or an opening step wherein the control circuit triggers an opening movement of the valve element in the direction of the open position, and a subsequent step for monitoring the closed or open positions of the valve element. In the step for monitoring the closed position, a non-closed position is detected on the basis of a discharge flow of the pressurized gas, of the condensate or of mixtures thereof in the discharge region or at the valve element. In the step for monitoring the open position, a discharge flow of the pressurized gas, of the condensate or of mixtures thereof in the discharge region or at the valve element is detected.

The subject-matter of the present invention is a method for fault monitoring of a shut-off valve of a condensate drainage means as well as a correspondingly equipped condensate drainage means.

In pressurised gas systems, such as compressed air systems, condensate essentially comprising water and oil arises, which originates for example from the lubricant of the compressors and the moisture content of the gas. This condensate usually has an adverse effect on the proper use of the pressurised gas system due to soiling, clogging-up and corrosion. It therefore has to be collected and from time to time discharged from the closed pressurised gas system, as far as possible without gas or compressed air being lost in larger quantities and the pressure in the system falling significantly.

It is known to carry out such discharge procedures at preset time intervals. Ideally, however, such discharge procedures are initiated as a function of the fill level of a collecting region provided for the condensate. Various methods and modes of procedure are known for the fill level measurement. Irrespective of this, however, there is the problem of the discharge valve not always being actuated reliably, since its valve element, for example, is subject to wear. But soiling such as deposits of condensate residues can also lead to the desired valve position not being set. Whereas the question as to whether the open position, in which condensate is discharged, is wholly or only partially reached is comparatively uncritical, it is very important that the closed position, in which the valve element lies adjacent to its associated valve seat in a sealing manner, is reliably reached, in order that an undesired drop in pressure does not occur due to leakage. At present, such malfunctions, if they are observed at all, are observed only indirectly through the drop in pressure, but usually too late or not at all, and are only corrected with the replacement of the condensate drainage means routinely provided for at maintenance intervals. There is therefore a need for such a malfunction to be detected as early as possible in order to avoid an unnecessary drop in pressure.

The problem of the present invention, therefore, is to make available a method for reliable fault monitoring of a condensate drainage means, so that a more reliable operation of a condensate drainage means is guaranteed. Furthermore, a correspondingly improved condensate drainage means is made available. This problem is solved by a method with the features of claim 1 and by a condensate drainage means according to the coordinated claim. Advantageous embodiments are in each case the subject-matter of the dependent claims. It should be pointed out that the features mentioned individually in the patent claims can be combined with one another in any technologically reasonable manner and display further embodiments of the invention. The description, in particular in connection with the figures, additionally characterises and specifies the invention.

The method according to the invention is provided for fault monitoring of a discharge valve of a condensate drainage means. The condensate drainage means according to the invention is used to discharge condensate from a pressurised gas system, in particular a compressed air system. Condensate in the sense of the invention means accumulations essentially comprising liquid components in the pressurised gas system. Condensate essentially comprises water, which originates from the moisture content of the gas, and oil, which can be traced back for example to the lubricant of the compressors.

The condensate drainage means according to the invention comprises a discharge valve, which comprises a valve element which can be actuated by a control circuit and which can be moved between a closed position and an open position in order, in its open position, to discharge pressurised condensate from the pressurised gas system via a discharge region of the condensate drainage means, said discharge region being disposed downstream of the valve element, and in order, in its closed position, to maintain the pressure in the pressurised gas system. For example, the valve element in the closed position lies adjacent to an associated valve seat in a sealing manner in order thus to maintain the pressure in the pressurised gas system. The method according to the invention comprises a closing step, in which the control circuit triggers a closing movement of the valve element in the direction of the closed position. To check whether the closed position is reached and/or is held, a subsequent step is also provided for monitoring the closed position of the valve element. This is monitoring step is carried out for example once, in a repeated sequence or continuously at least in sections, for example until an opening step in which the control circuit triggers an opening movement of the valve element in the direction of the open position. The monitoring step is preferably carried out continuously for the period during which the control circuit initiates and is intended to maintain a closed position of the valve element.

The method according to the invention is characterised in that, in the step for monitoring the closed position, a non-closed position is detected on the basis of a discharge flow, which can thus also be referred to as a leakage flow, of the pressurised gas, of the condensate or of mixtures thereof in the discharge region downstream of the valve element or if possible directly at the valve element. Leakage flow means a pressurised gas- and/or condensate-containing flow, which occurs on account of the malfunction of the shut-off valve in its closed position, because for example the closed position of the valve element is not reached or the valve element provides an insufficient seal. A detection of the malfunction has the advantage that an incorrect function of the condensate drainage means can be established in good time and the precautionary replacement of parts of the condensate drainage means at fixed maintenance intervals can be dispensed with. A very reliable malfunction detection is achieved by the detection of the leakage flow in the discharge region of the condensate drainage means, for example almost directly at the valve element.

The fault monitoring according to the invention has the advantage that maintenance or a replacement of components of the condensate drainage means can now be carried out solely in the case of a fault. Maintenance arising from actual wear characteristics and faulty behaviour carried out at fixed time intervals can advantageously be dispensed with. This is because the latter involves the drawback that maintenance is carried out only with the passage of time, i.e. on mere suspicion and without actual need, with the drawback that pressure is unnecessarily released in the pressure system and has to be built up again subsequently. The known mode of procedure, i.e. to carry out maintenance at preset service intervals, is also not directed towards the actual demands. For example, it is perfectly possible for a failure to occur before the routine maintenance replacement and not to be observed due to more than expected opening and closing movements of the valve. The fault monitoring according to the invention thus has the advantage that faults are detected in good time and unnecessary pressure losses are avoided.

Even though the method according to the invention is intended primarily for the detection of a leakage flow after a closed position of the valve element has been effected, the invention also relates to a method wherein monitoring takes place after an opening step, in which the control circuit triggers an opening movement of the valve element in the direction of the open position, to establish whether a discharge flow can be detected in the discharge region or if possible at the valve element. A check can thus be made as to whether the discharge procedure is being or has been carried out successfully. Furthermore, the invention relates to a combination of both methods, i.e. that of monitoring the closed position and that of monitoring the open position. The monitoring of the open position has in particular the advantage that after a malfunction, in which no discharge takes place after the detection of a condensate level to be discharged, possibly after repeated discharge attempts, an “all clear” can be given without visual or functional control if a successful discharge procedure has finally been detected.

Apart from the possibility of monitoring a diaphragm fault, the method according to the invention, in combination with a further sensor system, for example for the fill level monitoring of a condensate collecting region and/or monitoring of the valve actuation, also has the advantage that, in combination with this further sensor system, further functional monitoring of the entire condensate drainage means and/or the upstream and downstream components of the pressure system is enabled by means of a plausibility check.

For example, the detection or non-detection of the previously mentioned discharge flow after execution of the opening step, in which the valve element is moved into the open position, can be used to carry out a functional check on the fill level monitoring or vice versa. If, for example, a condensate level to be discharged is detected by the fill level monitoring and no discharge flow is detected after initiation of the opening step, this indicates a possible mechanical fault or soiling in the control of the valve or a total pressure loss in the pressurised gas system.

According to a preferred embodiment, the discharge flow is detected on the basis of the flow pressure thereby produced. For example, a switch is provided, the mobile actuation part whereof changes its position through the effect of the discharge flow and wherein this change of position brings about a change in the switching state of the switch. A low-cost detection sensor system can thus be provided.

In a further advantageous embodiment, the discharge flow is detected on the basis of the temperature drop thereby produced, as a result of which a very reliable and interference-proof detection of the malfunction is achieved. For example, at least one temperature sensor is provided which detects the cooling brought about by the expansion of the pressurised gas. For more precise and/or more reliable detection of the temperature drop, a further or a plurality of further temperature sensors is provided, which determine the ambient temperature and/or the pressurised-gas or condensate temperature. Alternatively, according to a further embodiment, a calorimetric determination of the change in the heat quantity of the discharge flow is provided in the case of the undesired discharge.

Heating, for example electric heating, is preferably carried out with a preset heat quantity of the discharge region and the discharge flow is detected on the basis of the resultant increase in temperature in the discharge region.

According to a preferred embodiment, not only a qualitative, but also a quantitative detection of the change in temperature takes place. The composition of the discharge or leakage flow can thus be determined on the basis of the value of the drop in temperature or the increase in temperature. For example, a greater increase in temperature or a smaller drop in temperature is to be expected in the case of a predominantly liquid-containing discharge flow and a smaller increase in temperature or a greater drop in temperature is to be expected in the case of a predominantly gaseous discharge flow, so that this enables conclusions to be drawn as to the composition and a more precise fault identification. The quantitative measurement thus has the advantage that any desired discharge procedure can also be monitored. On the basis of the expansion-related temperature changes, conclusions can be drawn as to the pressure of the pressurised gas system and its composition.

According to a preferred embodiment, because it is a particularly interference-proof one, a movement of a detection transmitter is brought about by the leakage flow, the movement and/or position of said detection transmitter being detected magnetically or inductively. For example, a permanent-magnetic detection transmitter is provided, the movement whereof is detected by means of an induction coil.

In the step for monitoring the closed position, an optical and/or acoustic fault signal is preferably initiated when the non-closed position is detected by the control circuit, in order in this way to initiate, for example, maintenance of the condensate drainage means.

The invention also relates to a condensate drainage means for a pressurised gas system. According to the invention, said condensate drainage means comprises the following: a control circuit, a discharge valve, which comprises a valve element which can be actuated by a control circuit and which can be moved between a closed position and an open position. The valve element is provided in order, in its open position, to discharge pressurised condensate from the pressurised gas system via the discharge region of the condensate drainage means and in order, in its closed position, to maintain the pressure in the pressurised gas system. The condensate drainage means according to the invention also comprises a detection device for detecting a flow discharge in the discharge region. According to the invention, the control circuit of the condensate drainage means is designed to carry out the method described above.

The detection of the malfunction has the advantage that an incorrect function of the condensate drainage means can be established in good time and the precautionary replacement of parts of the condensate drainage means at fixed maintenance intervals can thus be dispensed with. A very reliable malfunction detection is achieved by the detection of the leakage flow or discharge flow almost directly at the valve element. To avoid repetition, reference is made to the advantages of the method according to the invention also applicable in this regard.

The discharge or leakage flow is preferably detected by at least one temperature sensor and/or a sensor system comprising a flow pressure sensor.

The flow pressure sensor preferably comprises a magnetic or magnetisable detection transmitter which is preloaded against the direction of the discharge flow or leakage flow and which can be moved in the direction of the discharge or leakage flow, the movement and/or position of said detection transmitter being detected inductively or magnetically.

The discharge valve is preferably a diaphragm valve. The valve element is therefore a diaphragm, for example made of an elastic plastic. Diaphragm valves are well suited for regulating and shutting off volume flows. Since only the valve body and the diaphragm are in contact with the pressurised gas or the condensate, there are only minimal problems with wear.

Provision is preferably made such that pressurised gas is applied on the discharge valve by means of a control valve, in order to move the discharge valve at least into the open position.

The invention and the technical field are explained in greater detail below with the aid of the figures. It is pointed out that the figures show a particularly preferred variant of embodiment of the invention, but that the invention is not limited thereto. The following is shown diagrammatically in the figure:

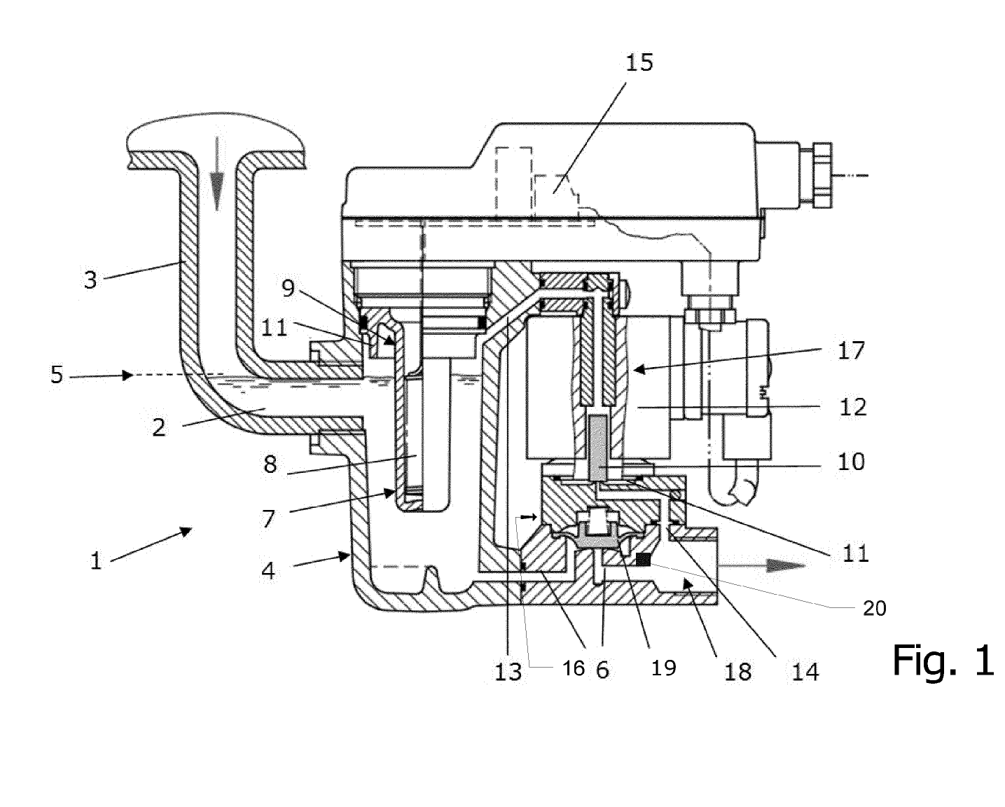

FIG. 1 a cross-sectional view of a generic condensate drainage means, in which the method according to the invention is used;

FIG. 1 shows a condensate drainage means 1 according to the invention for a compressed air system in a cross-sectional view. Condensate 2, which arises during the compression of the compressed air, is fed via supply line 3 to condensate drainage means 1. Condensate 2 is essentially condensed moisture of the ambient air, which is sucked in by a compressed air compressor not represented here. It usually also contains oily and particulate metal components.

Condensate 2 collects in a condensate collecting region 4 and, after reaching a defined fill level 5, is discharged via a discharge valve 16, provided in discharge line 6, and discharge region 18. In the embodiment shown in FIG. 1, discharge valve 16 is constituted as a diaphragm valve, i.e. discharge valve 16 comprises a diaphragm as valve element 19 which, in its closed position shown in FIG. 1, forms a seal with a valve seat in order thereby to close discharge line 6.

A capacitive sensor system 7 is provided for the quantitative measurement of the fill level in condensate collecting region 4. Sensor system 7 comprises at least one measuring capacitor 8, which has a capacitance that steadily changes as a function of the fill level of condensate 2 in condensate collecting region 4. The capacitive measurement thus detects the fill level of condensate collecting vessel 4 through the change in the electrical capacitance, when condensate 2 flows in as a dielectric medium. Measuring capacitor 8 forms an electromagnetic measurement field between a first firmly constituted capacitor electrode and a second counter-electrode provided by the wall of condensate collecting region 4. The shown device is very reliable even in the presence of considerable soiling, for example by rust from the compressed air lines or oil from the compressed air compressors. Sensor 7 is disposed in such a way that, even in the case of a flooded condensate collecting region 4, a zone 9 remains that is not wetted by condensate and is therefore clean, in order to avoid faulty measurements, which are caused for example by deposits which can lead to a measuring short-circuit

Clean zone 9 is defined by a diving bell-like recess 11. In the case of a completely flooded collecting region 4, i.e. even beyond the maximum provided fill level 5, no condensate 2 can penetrate into clean zone 9 or into diving bell-like recess 11. The inlet of compressed air line 13 is also provided in clean zone 9 above maximum provided fill level 5. The compressed air branched off via the latter serves to actuate discharge valve 16 or to hold the discharge valve in its closed position. Solenoid control valve 17 is provided for this purpose, which in the represented position ensures that compressed air is applied at diaphragm 19 of discharge valve 16 in such a way that discharge line 6 is closed and no condensate 2 can be discharged. Solenoid control valve 17 comprises a coil 12 and a permanent-magnetic armature 10, which is moved by the actuating current flowing through the coil from a rest position, for example the position corresponding to the closed position of discharge valve 16 shown in FIG. 1, into a setpoint position. The rest position results from the fact that armature 10 comprises an elastic sealing material at its end faces and, when its end face is applied against a valve seat 11 with the assistance of gravity and compressed air, a closure of compressed air discharge line 14 is brought about, so that the pressurisation of discharge valve 16 is maintained. An electronic control circuit 15 is provided for the actuation of solenoid control valve 17 and therefore of shut-off valve 16. In the closing step, a sufficient drop in the holding current ensures that armature 10 drops, with gravity and the compressed air of line 13, against a lower stop into a closed position, in which it closes compressed air discharge line 14, but at the same time compressed air is applied above diaphragm 19 and pushes the latter into the closed position. After initiation of this closing movement of diaphragm 19, pressure losses due to a leakage flow in the pressurised gas system should be avoided. A temperature sensor 20 is provided to check whether a leakage flow is occurring at valve element 19, for example because the latter has not reached its closed position or is no longer maintaining it, for example due to wear-related damage. By means of temperature sensor 20, control circuit 15 is able to detect a drop in temperature that can be traced back to the expansion of the undesired escape of pressurised gas (leakage flow). This monitoring takes place by means of control circuit 15 and, in the event of the detection of a leakage flow, a fault signal is generated which is displayed optically or acoustically.

1. A method for fault monitoring of a discharge valve of a condensate drainage means of a pressurized gas system, wherein the condensate drainage means includes a discharge valve including a valve element which can be actuated by a control circuit and moved between a closed position and an open position in order, in its open position, to discharge pressurized condensate from the pressurized gas system via a discharge region disposed behind the valve element and in order, in its closed position, to maintain the pressure in the pressurized gas system, wherein the method includes the following steps: a closing step, in which the control circuit triggers a closing movement of the valve element in the direction of the closed position, and
a subsequent step for monitoring the closed position of the valve element,
wherein a non-closed position is detected on the basis of a discharge flow of the pressurized gas, of the condensate or of mixtures thereof in the discharge region or at the valve element.

2. A method for fault monitoring of a discharge valve of a condensate drainage means of a pressurized gas system, wherein the condensate drainage means includes a discharge valve, including a valve element which can be actuated by a control circuit and which can be moved between a closed position and an open position in order, in its open position, to discharge pressurized condensate from the pressurized gas system via a discharge region disposed behind the valve element and in order, in its closed position, to maintain the pressure in the pressurized gas system, wherein the method includes the following steps: an opening step, in which the control circuit triggers an opening movement of the valve element in the direction of the open position, and
a subsequent step for monitoring the open position of the valve element,
wherein a discharge flow of the pressurized gas, of the condensate or of mixtures thereof is detected in the discharge region or at the valve element.

3. The method for fault monitoring according to claim 1, wherein the discharge flow is detected on the basis of the flow pressure thereby produced.

4. The method for fault monitoring according to claim 1, wherein the discharge flow is detected on the basis of the drop in temperature thereby produced.

5. The method for fault monitoring according to claim 1, wherein heating is carried out with a preset heat quantity of the discharge region and the discharge flow is detected on the basis of the resultant increase in temperature in the discharge region.

6. The method for fault monitoring according to claim 1, wherein the composition of the discharge flow is determined on the basis of the value of the drop in temperature or the increase in temperature.

7. The method for fault monitoring according to claim 1, wherein the discharge flow brings about a movement of a detection transmitter, the movement and/or position whereof is detected magnetically or inductively.

8. The method for fault monitoring according to claim 1, wherein, in the step for monitoring the closed position, an optical and/or an acoustic fault signal is initiated when the discharge flow is detected by the control circuit.

9. A condensate drainage means for a pressurized gas system, comprising a control circuit, a discharge valve, which includes a valve element which can be actuated by the control unit and which can be moved between a closed position and an open position in order, in its open position, to discharge pressurized condensate from the pressurized gas system via a discharge region disposed behind of the valve element and in order, in its closed position, to maintain the pressure in the pressurized gas system, and a detection device for detecting a discharge flow at the valve element, wherein the control circuit is configured to carry out the method according to claim 1.

10. A condensate drainage means according to claim 1, wherein the detection device further includes at least one temperature sensor and/or a flow pressure sensor.

11. The condensate drainage means according to claim 1, wherein the flow pressure sensor further includes a magnetic detection transmitter which is preloaded against the direction of the discharge flow and which can be moved in the direction of the discharge flow, the movement and/or position of said detection transmitter being detected inductively or magnetically.

12. The condensate drainage means according to claim 9, wherein the discharge valve is a diaphragm valve.

13. The condensate drainage means according to claim 9, further including a control valve configured for moving the discharge valve at least into the open position by means of the pressurized gas.
